(19) United States
(12) Patent Application Publication
(10) Pub. No.: US 2003/0097661 A1
(43) Pub. Date: May 22, 2003

(54) Time-shifted television over IP network system

(76) Inventors: Hua Harry Li, Palo Alto, CA (US); Bill Huang, Alameda, CA (US)

Correspondence Address: OPPENHEIMER WOLFF & DONNELLY, P. O. BOX 10356, PALO ALTO, CA, 94303, US

(21) Appl. No.: 09/994,482

(22) Filed: Nov. 26, 2001

Related U.S. Application Data
(60) Provisional application No. 60/332,465, filed on Nov. 16, 2001.

(51) Int. Cl. H04N 7/16; H04N 7/173

(52) U.S. Cl. 725/109; 725/25; 725/87; 725/126

(57) ABSTRACT

A system for providing IP centric, multi-channel, telecommunication services such as television on demand, video on demand, karaoke on demand, Internet access, and telephone services, said system comprising: (1) a media content creator subsystem for converting multiple format incoming video signal streams corresponding to multiple program files into IP based packets ready for transmission over a broadband network, the media content creator converting the incoming video signals into digital data and compressing the digital data based on multiple encoding standards into IP based packets; (2) a media streaming subsystem for storing the IP based packets, wherein the media streaming engine is capable of providing multiple streams of IP based packets for transmission based on user request, and wherein each stream of IP based packets represents the converted and encoded content of one user requested program; and (3) a content management subsystem for user authentication, billing, digital rights management protection and protection, etc.

### RELATED APPLICATIONS

The present application is related to and claims priority from the provisional patent application entitled “TIME-SHIFTED TELEVISION OVER IP NETWORK SYSTEM” serial No. ______ not assigned yet, filed on Nov. 16, 2001, by the same inventor, Mr. Hua Harry Li, and herein incorporated by reference.

### BRIEF DESCRIPTION OF THE INVENTION

1. Field of the Invention

The present invention relates generally to a system for providing telecommunication services and more particularly to a system and method for providing time-shifted television programming over broadband wide area networks.

2. Background of the Invention

With the advent of video processing/encoding, and IP networking in Telecom networks, Time-Shifted Television Over IP Networks, multimedia and video streaming over broadband networks are becoming available to meet the growing needs of users in the fields of video on demand, time-shifted television programming and related services.

Some existing Video on Demand (VOD) systems concentrate on a client-side solution. One such system allows television viewers to watch what they want, when they want it by recording television shows on the customer set-top box (STB) and creating customized television line-up for viewing at anytime. The STB records the programs the viewer may want to see. This system also enables the consumer to pause, rewind, instant replay and playback in slow motion any live television broadcast. However, this system has no broadband communication capability and does not support other telecommunication services such as web access and Internet browsing.

Another system provides a range of entertainment, information and communications services for the home and business markets, including video, data, voice, multimedia and Internet services. However, this system does not support both way communications, time-shifting television programming and any broadband communication services such as broadband Internet access.

Other systems may provide some of the hardware and software capabilities of video-on-demand solution. However, these systems lack the TV over IP capabilities and are incapable of providing an integrated IP-centric, telecom solution.

Therefore, it is desirable to provide a system capable of supporting unified services such as time-shifted TV programming, and video-on-demand over a broadband network, eliminating the need for customer side video encoding and storage requirement.

### SUMMARY OF THE INVENTION

One embodiment of the present invention relates to a system allowing a unified telecom infrastructure to emerge by providing enabling technology to deliver voice/data/video services for wired and wireless networks in a more cost effective manner giving end users simple, easy to use solutions to meet their time-shifted TV programming and video on demand need.

Briefly, the present invention comprises of three main sub-systems: (1) a media content creator, (2) a media streaming engine with content storage, switching, IP packets routing, and delivering capability, and (3) a billing, user authentication and management, content protection and digital right management capability. The unique characteristics of the present invention are embodied in a system and method of providing IP-centric TV over IP (TVoIP) solution: (1) The TVoIP system receives multiple channel video input signals either in S-video format, NTSC/PAL composite TV signal format, or RGB component video format, then encodes multiple video input signals into MPEG1, and/or MPEG2, and/or MPEG4, and/or H.263 digital format. Upon the completion of the MPEG encoding, the TVoIP system further processes these digital MPEG video signals in real time to convert the signals to various IP (Internet Protocol) packets suitable for Internet transmission and delivery. (2) The TVoIP system archives the processed video streams, which can be off-the-air television programming, cable TV programming, or satellite TV programming, or can be from a source of DVD (Digital Video Disk), VCD (Video CD), etc. These processed video streams will be stored in an indexed, large capacity Hard Disk Drive (HDD), indexed. In one embodiment, the TVoIPTM system is! designed to hold enough HDD space to allow constant recording of multiple video inputs (24 hours a day, 7 days a week) with software management of the recording/content. The system is thus capable of providing users with any programs broadcast during the past 7 days, and such programs may be viewed in any user selected order and at any given time instance. (3) The signaling and management software that manages the user base, performs user authentication, conducts billing, and manages the video content for digital rights protections, as well as conducts bandwidth management and insures quality of services. Furthermore, the system of the present invention is capable of providing video on demand, web browsing, gaming, voice over IP telephone, and video telephone communication in addition to time shifted television programming, available to wired and wireless broadband IP users.

Accordingly, one aspect of the present invention is embodied in a system for providing IP centric, multi-channel, telecommunication services such as television on demand, video on demand, karaoke on demand, Internet access, and telephone services. The system comprises: (1) a media content creator subsystem for converting multiple format incoming video signal streams corresponding to multiple program files into IP based packets ready for transmission over a broadband network, the media content creator converting the incoming video signals into digital data and compressing the digital data based on multiple encoding standards into IP based packets; (2) a media streaming subsystem for storing the IP based packets, wherein the media streaming engine is capable of providing multiple streams of IP based packets for transmission based on user request, and wherein each stream of IP based packets represents the converted and encoded content of one user requested program; and (3) a content management subsystem for user authentication, billing, digital rights management protection, etc.

Yet another aspect of the present invention is embodied in a method for providing IP centric telecommunication services including but not limited to television on demand, video on demand, karaoke on demand, Internet access, and telephone services, the method comprising, receiving multiple format incoming video signals from multiple sources; converting the incoming video signals into digital data; encoding the digital data into IP based packets based on multiple compression standards, wherein the IP packets are made ready for transmission over a network; storing the IP based packets in an indexed, quickly accessible database; and providing multiple streams of IP based packets to multiple users upon request, wherein each stream of IP based packets may represent the content of one program selected by a user.

### BRIEF DESCRIPTION OF THE DRAWINGS

FIG. 1 is an illustration of one application scenario according to one embodiment of the present invention;

FIG. 2 is a simplified block diagram depicting one embodiment of the application scenario illustrated in FIG. 1;

FIG. 3 is a conceptual illustration of the multimedia transmission system according to one embodiment of the present invention;

FIG. 4 is a flow diagram illustrating the principle operation steps implemented by the system described in FIG. 3;

FIG. 5 is a block diagram illustrating one embodiment of the media content creation unit of FIG. 3;

FIG. 6 illustrates one embodiment of the media streaming subsystem according to the present invention;

FIG. 7 is a flow diagram illustrating the principle operation steps of implemented by the of FIG. 6;

FIG. 8 illustrates one embodiment of an output subsystem of the data creation and transmission system 12 (FIG. 1);

FIG. 9 is a simplified block diagram illustrating one embodiment of a Set Top Box (STB);

FIG. 10 is a flow diagram illustrating the principle operation steps implemented by the STB;

FIG. 11 illustrates one example of a GUI interface according to the present invention;

FIG. 12 illustrates one example of the scalable RAID system housing the data creator and transmission system 12.

### DETAILED DESCRIPTION OF THE INVENTION

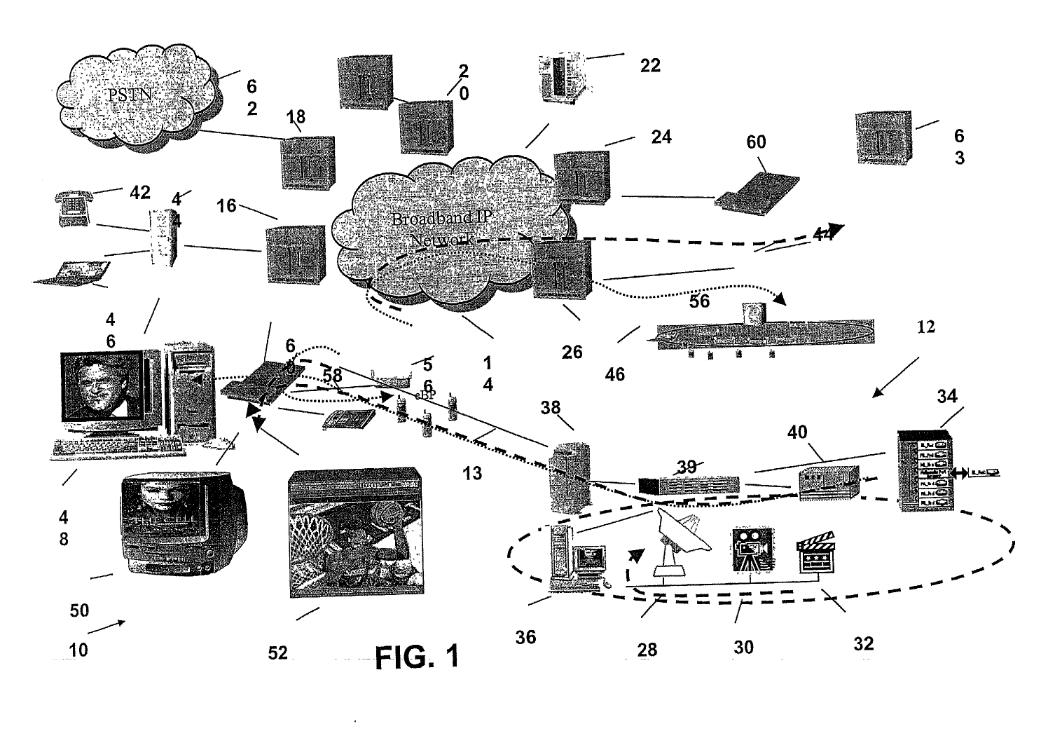

FIG. 1 is an illustration of one application scenario according to the present invention. According to one embodiment of the present invention, a system is provided that is comprised of a data creation and transmission unit 12 connected through a wide area network 14 to various network hubs 16-26 used to link users to unit 12. In this embodiment, the communication links 13 between the wide area network 14, the content creation and transmission unit 12, and the various hubs 16-26 provide broadband Internet Protocol (IP) based channels. The term “broadband” as used herein refers to communication in which a wide band of frequencies is available to transmit information. The wide band of frequencies allow for multiplexing of data that may be concurrently transmitted on many different frequencies or channels within the band. Broadband communication allows for the transmission of more data in a given time thus providing very high data transmission rate. In contrast, “narrowband” refers to a communication channel that is not wide band and sometimes is defined as being wide enough to carry voice.

The actual width of a broadband communication channel may vary from technology to technology. In one embodiment, the backbone carrying the broadband communication may be based on a fast Ethernet architecture. Alternatively, the broadband network service may be based on an Asynchronous Digital Subscriber Line (ASDL) system.

The system 12 processes user requests for various data files and/or telecommunication services. The term “telecommunication services” as used herein refers to a variety of such telecommunication services including time shifted television programming available on demand, video on demand, near video on demand, Internet services, telephone services, teleconferencing services, etc. In one embodiment, the system 12 may respond to user inputs by providing encoding and forwarding a real time program as it is receiving the program data stream via satellite 28, cable 30 or other sources such as DVD or video 32. Alternatively, the content creation and transmission system 12 may respond to user input by retrieving the requested data file from its storage unit 34. A content creator server 36 may manage the data creation for the streaming data feed. The real time data may be channeled to the storage unit 34 and the streaming engine 38 thru a switch 39. In a more complex system, a plurality of switches are used with a plurality of streaming media servers 38 and storage units 34. The switches 39 may for example be fiber channel switches. Alternatively, the switches 39 may be ultra SCSI switches. Small Computer System Interface (SCSI) is a set of evolving ANSI standard electronic interfaces that allow personal computers to communicate with peripheral hardware such as disk drives, tape drives, CD-ROM drives, printers, and scanners faster and more flexibly than previous interfaces. The streaming engine 38 manages the user requests by retrieving from the storage unit 34 or from the content creation unit 36 the requested data files, encoding them based on the appropriate protocol, and transmitting them to the user thru the broadband communication channels. A media database management server 40 may manage the storage unit operations.

Once the user response has been processed at the content creation and processing system 12, the requested data files are transmitted to the user via a series of gateways and routers. Hub 16 is an illustrative example of a gateway according to one embodiment of the present invention. The gateway 16 may convert the system 12 via the broadband communication network 14 to a variety of communication systems based on various technologies such as Plain Old Telephone Service (POTS) or an Integrated Service Digital Network (ISDN). The communication link to the broadband wide area network 14 via hub 16 may be provided by an intermediary service provider system herein represented by the server 44. A subscriber or user may be using a laptop computer 46 or a desk top computer 48 connected to the server 44 to receive and use the data files. The service provider 44 may be providing a Digital Subscriber Line (DSL) link, an ISDN link or a regular analog telephone link to the hub 16.

The broadband gateway 16 may also be capable of providing a variety of telecommunication services including analog telephone service, regular television and set top box (STB) 50 or digital television 52, digital telephone communications means such as cellular phone 56, or a Private Branch Exchange (PBX) service 58, and various broadband services such as television over cable, video on demand, near video on demand, as well karaoke on demand. A broadband switch, bridge or hub 60 may be used to control and subdivide the traffic over the broadband connection into smaller bandwidth channels. For example a 2 GB broadband channel may be divided into 24 10/100 MB Ethernet links. The data storage and processing capabilities of the content creation and processing unit 12 enables the system to provide time-shifted television services, wherein programming for N number of channels may be available on demand to a user regardless of his location within the network 14.

Gateway 18 may link a Public Switching Telephone Network (PSTN) 62 to the broadband network 14 and providing its services to the users. Similarly, a gateway 20 may provide a link to other gateways and connect other wide area networks to the network 14.

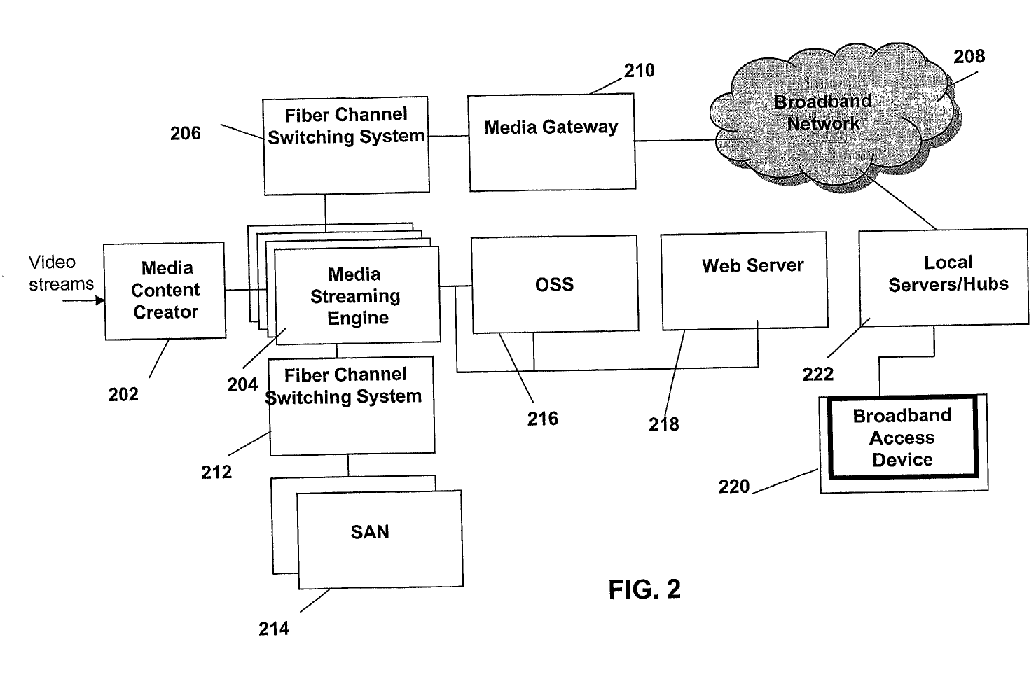

FIG. 2 is a simplified block diagram corresponding to one embodiment of the application scenario illustrated in FIG. 1. The media content creators 202 (shown as 36 in FIG. 1) receive and process incoming video streams by encoding the video streams and forwarding them to media streaming engines 204 (shown as 38 in FIG. 1). In addition, the media content creator 202 may manage the operations of each incoming channel for hard wire failure problems and smooth transition between channels in case of failure.

The media streaming engines 204 process user requests in a timely fashion, retrieve the requested data files from the incoming real data generated by the media content creation units or from the storage unit 34 (FIG. 1). The media streaming engines 204 are coupled to the broadband network 208 thru a broadband fiber channel switching system 206 and the media gateway 210. The switching system 206 may comprise a level 2/level 3 switch and a router. The media streaming engines 204 may also be coupled to a storage area network (SAN) 214 thru fiber channel switching system 212. In an alternative embodiment, an Ultra SCSI switching system may be instead of the fiber channel switching system 206 and 212.

An operating system server 216 may be used to manage the overall operation of the plurality of media streaming engines 204 and the plurality of storage systems within the storage area network 214. A web server 218 may provide web page and user interfaces for the user, accessible through their set top box (STB) units. Using this interface, the users may access a plurality of services provided through the system.

The user may be accessing the broadband network thru a broadband access device 220 connected to the wide area network 208 via a local server or service provider 222. The user access device 220 may for example be a STB device coupled to a television. Furthermore, the local server or hub 222 connecting the access device 220 may be the servers of an Internet Service Provider (ISP).

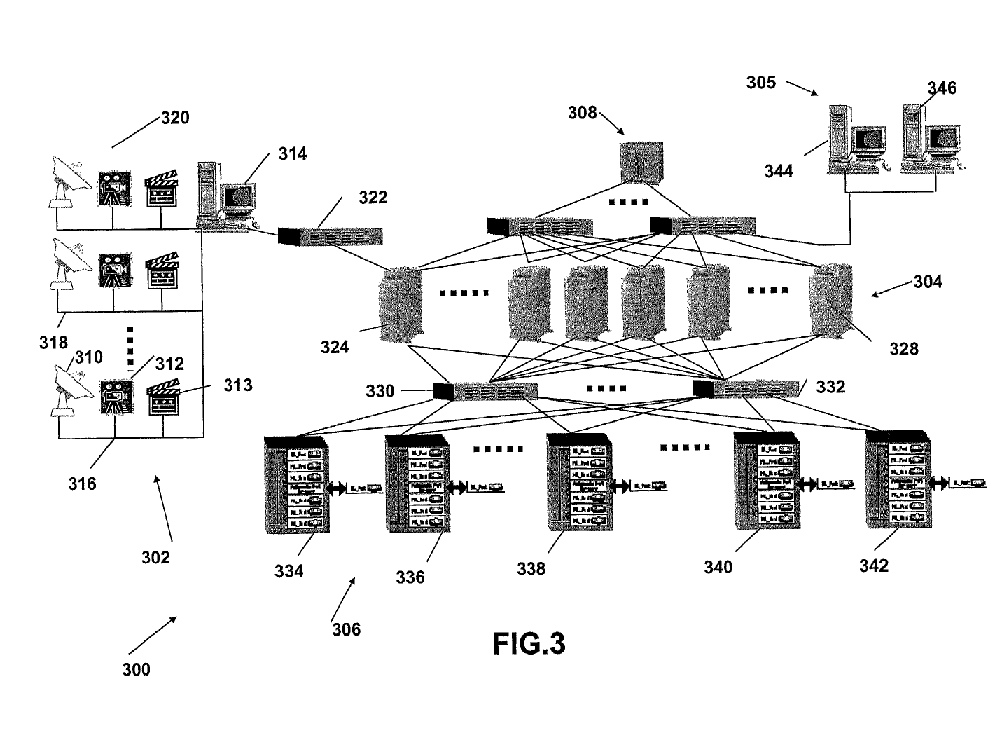

FIG. 3 is a conceptual illustration of the multimedia transmission system according to one embodiment of the present invention. As illustrated, the transmission system 300 may be comprised of a content creation unit 302, a processing unit 304, a storage unit 306, and an output unit 308.

The content creation unit 302 usually functions as the input unit for the transmission system 300. The input unit may receive data from a variety of data sources including but not limited to live television broadcast via satellite 310, cable or antenna, DVD input 312, and/or video input 313. The system receives data input through its various input channels and encodes the received information based on the appropriate transmission protocol into MPEG 1 or MPEG 2 as an example. It will be understood by those skilled in the art that implementation of the present invention is not limited to a particular encoding protocol. The input system 302 may also coordinate channel operations.

The processing server 314 manages the operations of the data creation unit. The functions of the processing server 314 may include such tasks as start and stop capturing, channel management issues such as smooth swapping or transition from one channel to another in case of hardwire channel failure and other such management issues. Furthermore, the processing server 314 may perform such functions as turning channels on and off, or controlling the format, the resolution and the speed of the encoding process.

The input system 302 may include many receiving channels and be implemented within a box comprising, wherein each blade or board within the box may be capable of supporting 8 to 16 incoming channels of data. The box containing the components of the input system may be mounted on a rack, along with the various other components comprising the transmission system 300. As illustrated in FIG. 3, the content creation unit may receive simultaneous input from multiple channels 316, 318 and 320. It will be understood by those skilled in the art that the architecture of the content creation unit 36 is designed to be scalable, so that any increase in the number of the inputs may be easily absorbed by the system.

The streaming engine processing system 304 (shown as 38 in FIG. 1) directs the information flow from the content creation system 302 (shown as 35 in FIG. 1) to at least two possible destinations. One destination may be the storage unit 306 (shown as 34 in FIG. 1) wherein the incoming programming data is stored for future retrieval and use. Additionally, the incoming data may be directed to the gateway and routed to users that requested real time programming such a real time news broadcast.

Alternatively, user requests for previously stored programming is processed by the media streaming engine 304. Such requests must be processed and managed in a time efficient manner wherein the media streaming engine 304 locates the requested programs, retrieves the programs and forwards them to the output unit 308 to be transmitted to the requesting user.

In one embodiment of the present invention, one week of television programming produced for a particular geographic region may be stored in the storage unit 306 (shown as 34 in FIG. 1). It will be appreciated by those skilled in the art that the design of the data creation and transmission system (12 in FIG. 1) and its storage subsystem 306 may be scalable in order to allow larger storage capacities and greater traffic in the system.

The media streaming engine 304 unit may be comprising of at least one switch 322 connecting the content creation unit 302 to the streaming engine unit 304. It will be apparent to those skilled in the art that the switch 322 may be an optical switch. Alternatively, an ultra SCSI switch or an Ethernet switch may be used. The switches facilitate selection and communication between a bank of media creation servers 324 through 328, multiple storage units 334 through 342 and multiple content creation units 302. An operation support subsystem shown as server 344 may be managing the interoperation of the many media streaming engine servers 324-328 and the plurality of storage devices 334-342. Additionally, a web server subsystem 346 may be presenting the interface to the user via a web site. It will be understood by those skilled in the art that the web server 346 and the operation server 344 may reside on the same physical unit or may be spread out over several servers. The user inputs may be received through the web server and processed by the streaming engine unit 304 in order to retrieve the various data files requested by the user pass onto the output unit 308 to forward to the requesting user.

The storage unit 306 (34 as shown in FIG. 1) comprises of a plurality of storage devices scaled to store large amounts of data from the incoming streaming video streams. It will be apparent to those skilled in the art that the size of the storage unit 306 is dependant on the number of files that need to be stored on a given system. The storage subsystem 306 comprises of a RAID array of large capacity hard disk drives (HDD). The amount of storage capacity required is proportional to the amount of data that has to be stored. For example, 11 terabytes of storage capacity may be used to store twenty four hours of programming over a span of one week, produced for fifty channels.

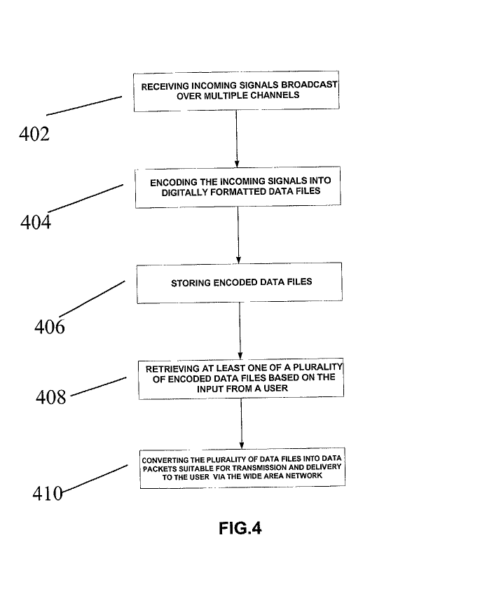

FIG. 4 is a flow diagram illustrating the principle operation steps implemented by the system described in FIG. 3. In step 402, the data creation and transmission system 12 of the present invention receives multiple channels of video input signals from multiple sources. The incoming video input signals may be received in many different formats such as S-video, NTSC/PAL composite TV signal, or RGB component video format. The incoming video signals may be generated by a plurality of sources including but not limited to off-the-air television signals captured by an antenna, cable, satellite, Digital Video Disk (DVD), Video CD (VCD), etc.

In step 404, the incoming analog video signals may be converted into digital data. The digital data is then encoded using one of many compression standards such as MPEG1, MPEG2 or MPEG4. Several versions of a program file may be created by encoding the corresponding incoming, converted digital data representing the content of the program based on different encoding standards. Furthermore, the encoded data may formatted into IP based data packets suitable for transmission over a broadband network such as the Internet.

In step 406, the digitized, encoded and formatted IP based data packets are indexed by the media streaming engine and stored the IP based data packets in large capacity storage subsystems 306. In one embodiment, the storage sub-system comprises of a scalable RAID of Hard Disk Drives (HDD) designed to store and retrieve data at very high speeds. In order to store seven days of programming, 24 hours of programming per day broadcast over fifty channels a storage capacity of over 11 Terabytes may be required. It will be appreciated by those skilled in the art, that the implementation of a high capacity, high speed, reliable storage sub-system capable of storing large amounts of data and retrieving the same in response to user request for a particular program file may be done using architectures other than a RAID storage system.

In step 408, the media streaming subsystem 304 may retrieve data packets corresponding to a program file requested by a remote user in an efficient manner. In one embodiment of the present invention, the user may be located anywhere within the network and may access the data using any access device that is broadband enabled.

In step 410, data files retrieved in response to the user request are transmitted through an output sub-system (308 as shown in FIG. 3) and via the broadband network. The output system (308 in FIG. 3) allows for seamless integration of the television programming over the Internet with other telecommunication services such as web browsing, gaming, voice over IP telephone and video telephone communication, to both wired and wireless broadband IP users.

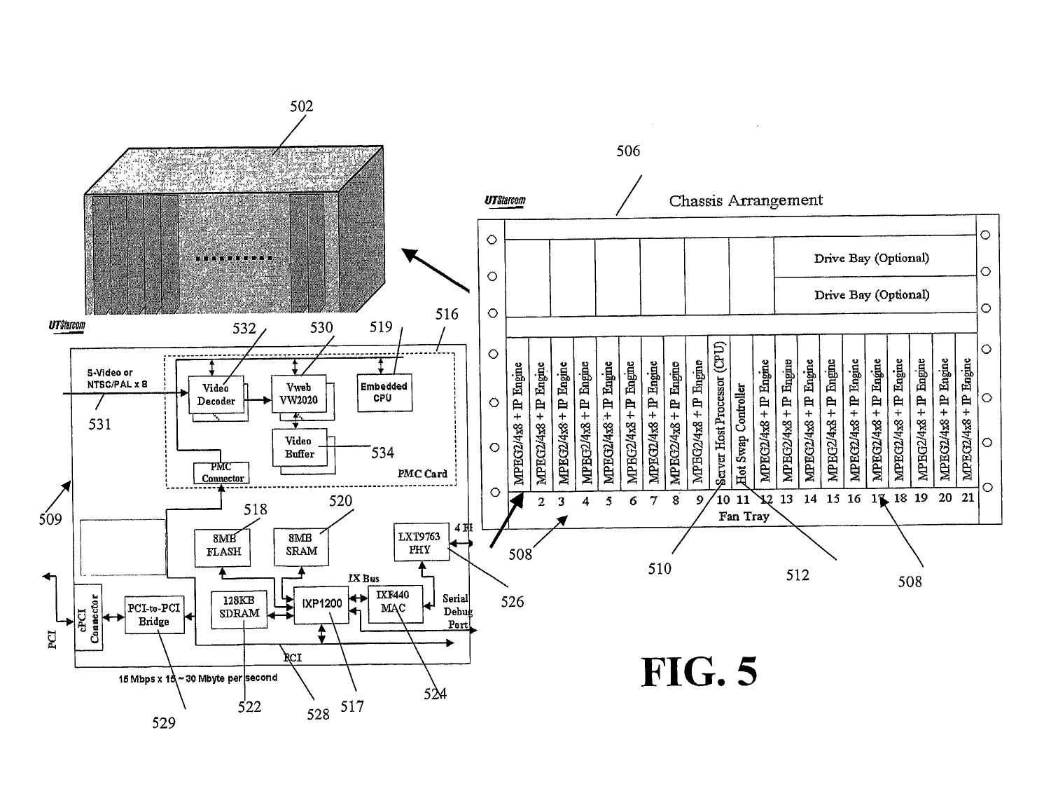

FIG. 5 is a block diagram illustrating one embodiment of the media content creation unit of the data creation and transmission system of FIG. 3. In one embodiment, the media content creator 500 (shown as 35 in FIG. 1) is a subsystem whose functionality includes: (1) taking multiple video inputs either in digital format or analog format, and compressing them in MPEG1/2 or MPEG4 form, and H263; (2) providing state-of-the-art high density, high availability, and hot swap capabilities to deliver scalable video streams.

As shown in FIG. 5, the media content creator 500 comprises of a chassis box 502 housing a server host processor module 510 that is responsible for the management and control of the media content creator 500 and communicates with other modules of the data creation and transmission system 12 (FIG. 1). As shown in the view 506, the chassis is capable of hosting multiple video encoding cards 508, a server host processor card 510, and a hot-swap controller module card 512. A block level view of a video encoding card 508 is shown in view 509. Each video encoding card 508 includes a carrier board 514 (e.g., a mother board), and a high density, multiple channel video encoding daughter card 516 supporting MPEG1, MPEG2, MPEG4 and H263 encoding.

The carrier card (board) 514 consists of high performance a network processor 517, Random Access Memory (RAM 520 and 522), Read Only Memory (ROM 518), Ethernet Media Access Control (MAC) 524, at least one Physical Layer Interface (PHY) 526 processor, a PCI bus 528 which links the processors and ROM and RAM memory together, and a PCI to PCI bridge 529 providing connectivity with the other subsystems.

The video encoding daughter card 516 is illustrated inside the dashed line square. The daughter video encoding card 516 hosts multiple channel video encoding processors 530 and is implemented with 8 such channels working concurrently in a parallel fashion. It will be understood by those skilled in the art that other arrangements may be used to implement the daughter video encoding card 516. An embedded central processing unit (CPU) 519 coordinates the operation between daughter video encoding card 516 and the mother board 514. The embedded central processing unit (CPU) 519 also manages hardware and software resources of the daughter card 516. An incoming video stream 536 from one of a plurality of sources (e.g. as S-video or NTSC/PAL video source) is received as input to one of the plurality of video decoders 532 which decodes the incoming data stream 531 and outputs to a corresponding video encoding processor 530. A video buffer 534 may be used for temporary storage of the decode video streams.

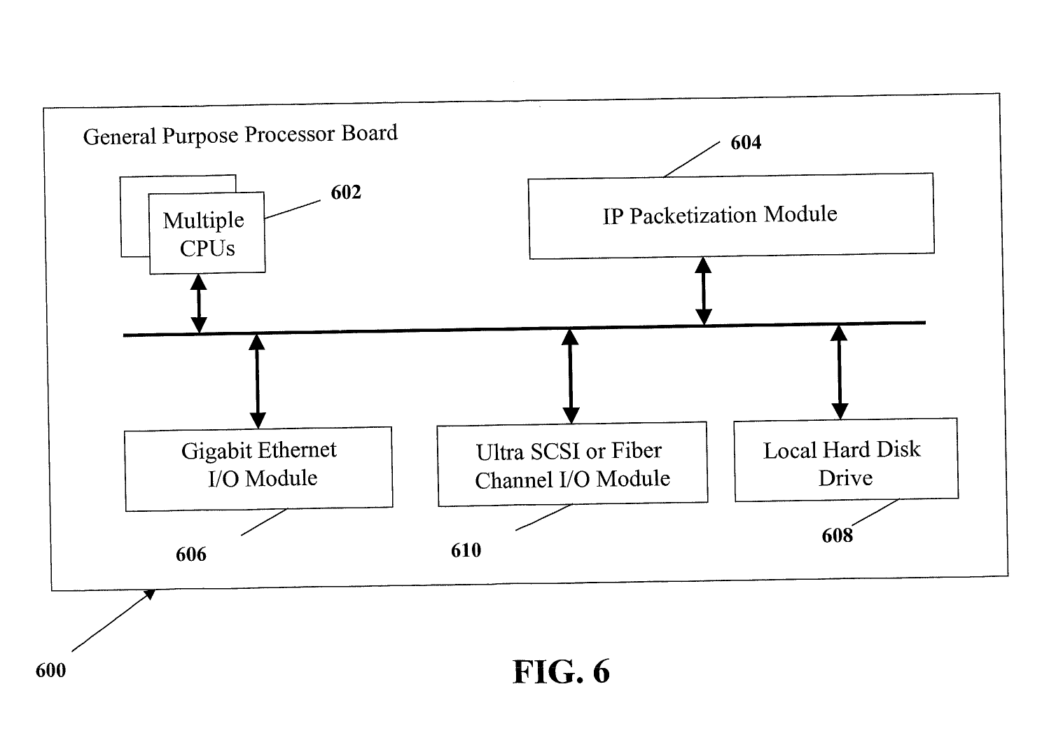

FIG. 6 is a block diagram illustrating one embodiment of the media streaming subsystem of FIG. 3. The media-streaming engine 600 (shown as 304 in FIG. 3) comprises of multiple general-purpose processors 602, such as Pentium™ processors, used to accelerate the computational tasks to stream MPEG videos. The streaming media engine 600 further includes a packetization module 604 to form and process IP packets in real time. In an alternative embodiment, the packetization process may be performed by the media content creation unit 35 (as shown in FIG. 1). After being encoded by content creation unit 302 (FIG. 3), the incoming video streams from media content creator will pass through Gigabit Ethernet I/O module 606 and reach the packetization module 604 for further processing before being transmitted by the to users. Alternatively, the encoded and packetized video streams are directed to the local HDD 608 for temporary storage before being sent to users and sent to the storage system 306 (FIG. 3). The local HDD 608 provides storage space as the top tier of the hierarchical structure of the HDD storage system. The media streaming engine 600 communicates with other modules via the Ultra SCSI/fiber channel I/O module 610.

In an alternative embodiment, the packetization is performed by the content creation subsystem 302 (FIG. 3).

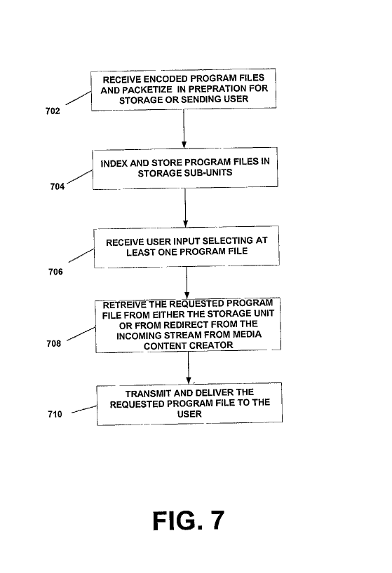

FIG. 7 is a flow diagram illustrating the principle operation steps implemented by the media streaming subsystem of FIG. 6. In step 702, the media streaming engine 600 (FIG. 6) receives encoded streaming program files from the media creation subsystem 302 (FIG. 3). The streaming program files are packetized and prepared for transmission by the media streaming engine 600 (FIG. 6). In an alternative embodiment, the packetization operation is performed by the media content creator 500. In step 704, the data files are indexed and stored in the storage subsystem 306 (FIG. 3), available for quick retrieval. In step 706, the media streaming subsystem may receive a request for a specific file from a user input selecting. In step 708, the streaming media subsystem 600 (FIG. 6) retrieves the requested program file either from the storage subsystem or from the real time incoming program stream. In step 710 the media streaming subsystem 600 sends the file to the output subsystem for transmission to the user.

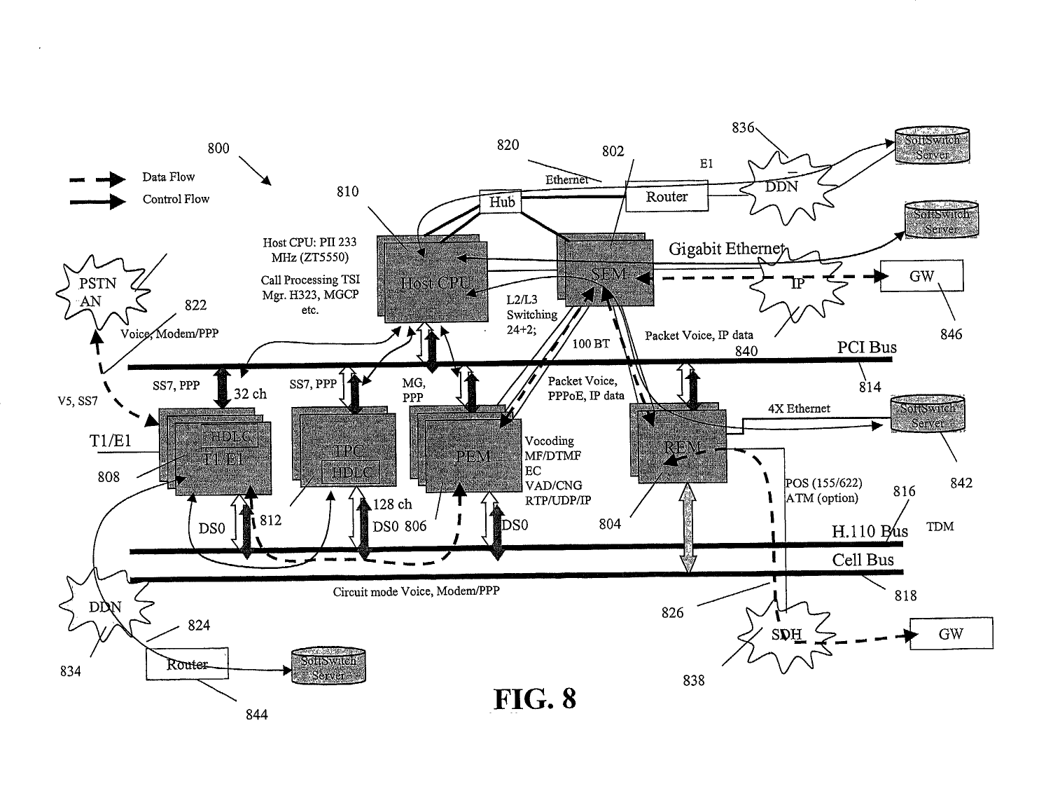

FIG. 8 illustrates one embodiment of an output subsystem of the data creation and transmission system 12 (FIG. 1). The output subsystem 800 (shown as 308 in FIG. 3) allows for seamless integration of various telecommunication services for delivering video/voice/data unified services. The output system 800 may be designed to accomplish wire-speed IP routing and provide a single service access point for multiple telecom services and connections to the existing traditional service-specific networks and access networks. The features of the output subsystem 800 include: (1) a plurality of Voice over IP (VoIP)) and Remote Access Services (RAS) ports in a single chassis (up to 1920 in one embodiment); (2) non-blocking switching capacity (from 6.4 Gbps to 20 Gbps in one embodiment); (3) packet forwarding (up to of 5 million pps packets per second in one embodiment); (4) wire-Speed IP routing at Layer 3 and wire-speed switching at Layer 2, (5) a physical interface; and (6) WDM (Wavelength Division Multiplexing) optical broadband networking. The physical interface is capable of implementing various communication protocols such as Synchronous Transport Signal Level 1-4 (STM-1, STM-4), Packet over SONET (POS), ATM (Asynchronous Transfer Mode), and 100 BaseT Ethernet, Gigabit Ethernet, as well as T1, E1. The STM-1/4 (Synchronous Transport Signal Level 1-4) and Gigabit Ethernet may be short/long haul selectable using a hot-swappable GBIC module.

The signal flow and the control path of the output subsystem 800 are dictated by the bus system in the design. The signal flow and control path comprise of: a PCI bus 814 mainly responsible for control signals, a H.110 bus 816 responsible for Time Division Multiplexing (TDM) data flow, a cell bus 818 for data flow required for ATM applications, and Ethernet links 820-830 for both data flow and control flow. FIG. 8 further illustrates one embodiment of the application environment for the output subsystem 800, which covers PSTN 832 (Public Switched Telephone Network), Digital Data Network (DDN) 834 and 836 (Digital Date Network), and 838 POS and ATM 840 (options).

From a functionality point of view, the output unit 800 is an IP-based switching system designed as a layered network architecture to support end-to-end communications and voice and data services. The hardware supports both fast Ethernet and gigabit Ethernet, POS, and IP over Asynchronous Transfer Mode (IPoATM) technologies. The output subsystem 800 may also support communication between legacy telephone equipment and next-generation IP devices. Object-oriented distributed server clusters support signaling, software enabled management, Operating system server (OSS), billing, and customer services, as well as Quality of Services (QoS). The utilization of IP centric technology allows the telecom service providers to deliver unified services (voice, data, and multimedia data) over a single network to achieve better cost/performance ratio and improve bandwidth efficiency. The output unit 800 may be implemented by a gateway, which provides a single service access point for multiple telecom services and connections to the existing traditional service-specific networks such as the Internet and access networks such as the PSTN network 850. The features of output subsystem 800 may be implemented using distributed modules. This distributed modularized architecture collectively realizes layer 3 wire speed routing. The output unit includes E1/T1/J1 modules 808 (up to 16 modules in this example), a Packet Engine Module (PEM) 806 with voice encoding capabilities, a Switch Engine Module (SEM) 802 with multiple port hubs for redundancy (8 port hubs in this example), a Routing Engine Module (REM) 804 operating with a plurality of protocols such as Optical Carrier standard levels OC-3/OC-12, POS, Fast Ethernet and Gigabit Ethernet Combo, and OC-3 ATM and STM-1 Time Division Multiplexing (TDM) interface modules. Furthermore, the output unit 800 supports multiple services such as Personal Access System (PAS), Public Switched Telephone Network (PSTN), IP based data including video, communication, intelligent telephone services and H.323 IP telephony capabilities. The output unit may also supports broad range of access networks support including POTS, Integrated Services Digital Network (ISDN), Personal Access System (PAS), Digital Subscriber Line (DSL) and Digital Data Network (DDN). The Telecom Operations Map defined by Tele-management Forum is employed as the guideline in order to interface with other service-specific switches, network management, billing systems etc.

The output unit 800 system configuration may be implemented as described herein forward.

A host machine 810 (Back plane) is controlling and coordinating the operation of each sub-system, REM 804, SEM 802, and PEM 806. In one embodiment, Open System Interconnection (OSI) standard layer 2 and 3 protocols may be running on the host machine 810 for routing and forwarding controls. The back plane is the host module 810 consisting of a general purpose processor with a real time operating system. Its main function is to control and coordinate the operations of each subsystem. In addition, the software routing engine may reside on the back plane 810. The back plane 810 has the function of common control tasks for IP routing. The back plane 810 also host routing stacks such as OSPF (Open Shortest Path First), RIP (Routing Information Protocol), BGP-4 (boarder gateway protocol) among others, and it may also support management tasks, such as CLI (Command Line Interface), SNMP etc.

The output system 800 may also include an SEM 802 comprised of a switching fabric directing internal traffic among each individual subsystems of the output system, allowing for layer 2/layer 3 non-blocking switching. The main function of the SEM 802 is to direct traffic to and from each individual board in a non-blocking fashion. The SEM 802 may be implemented using off the shelf components such as various L2/L3 switching chipsets. Working together with SEM onboard host CPU (non shown here), the switching chipset provides non-blocking, Quality of Services (QoS) ready features.

The Routing Engine Module (REM) 804 is a routing unit capable of performing layer 3 non-blocking packet forwarding. The input/output (I/O) interfaces support fast Ethernet, Gigabit Ethernet, OC3-12 for POS/SDH (Packet over SONET/Synchronous Digital Hierarchy), ATM Adaptation Layer 2 (AAL2) (for 3G Wireless) and AAL5. The REM module 804 performs layer 3 non-blocking packets forwarding and routing functions. The REM module 804 supports various interfacing schemes including ATM and POS I/O interfaces for inter-connect SDH or ATM transport for long haul transmission uplinks. The REM module 804 may connect to ATM based access equipment, such as DSLAM (Digital Subscriber Line Access Multiplexer), W-CDMA (Wideband Code Division Multiplex Access) node-b, or ATM concentrators. High performance, Reduced Instruction set Computer (RISC) network processors and executive processors (neither are shown here) are used to implement the required routing functions. The network processor offers programmable interfaces to support FE (Fast Ethernet), POS, and ATM. The RISC (Reduced Instruction Set Computer) processors can also perform ATM AAL5 (ATM Adaptation Layer 5) SAR (Segmentation and Reassembly) functions. Other possible applications of the RISC processor and the executive processor are AAL2 SAR, PPP (Point to Point Protocol) over Ethernet, PPP over ATM, or channel encryption for wireless applications.

The Packet Engine Module (PEM) 806 supports multimedia data communications including Voice coding (Vocoding G711), MF/DTMF (multi-frequency/dual tone multifrequency), VAD/CNG (Voice Activated Detection, Comfort Noise Detection), and packetization of Routing transfer protocol (RTP), user datagram protocol (UDP) and IP for supporting multimedia data communications.

The PEM 806 (packet engine module) performs two functions. First, it converts circuit mode signals, such as voice or modem signals, to packet signals. Secondly, it performs voice packetization. The packetization and voice coding (vocoding) are separated for greater flexibility and easy upgradability. Two PMC form factor cards are utilized for high density voice encoding/decoding for either VoIP (Voice over IP) or VOATM (Voice over ATM) (VOX PMC and Uniporte PMC), etc. The real time protocol processing is performed by a high-speed network processor such as the processor 517 (FIG. 5).

The PEM 806 includes a T1/E1 Module 808 and a STM-1 TDM (Time Division Multiplexing) Interface Module for T1/E1 interface, STM-1, STM-4, POS, and ATM interfaces. The TPC module 812, is capable of extracting timing signals from the input, and the T1/E1 module 808. The TPC module 812 is the interface between the output unit 800 and the various types of communication lines such as a digital line, a fiber optic or ATM line. The data transmitted by the output subsystem 800, may be routed through routers 844, softswitches 842 and various gateways 846.

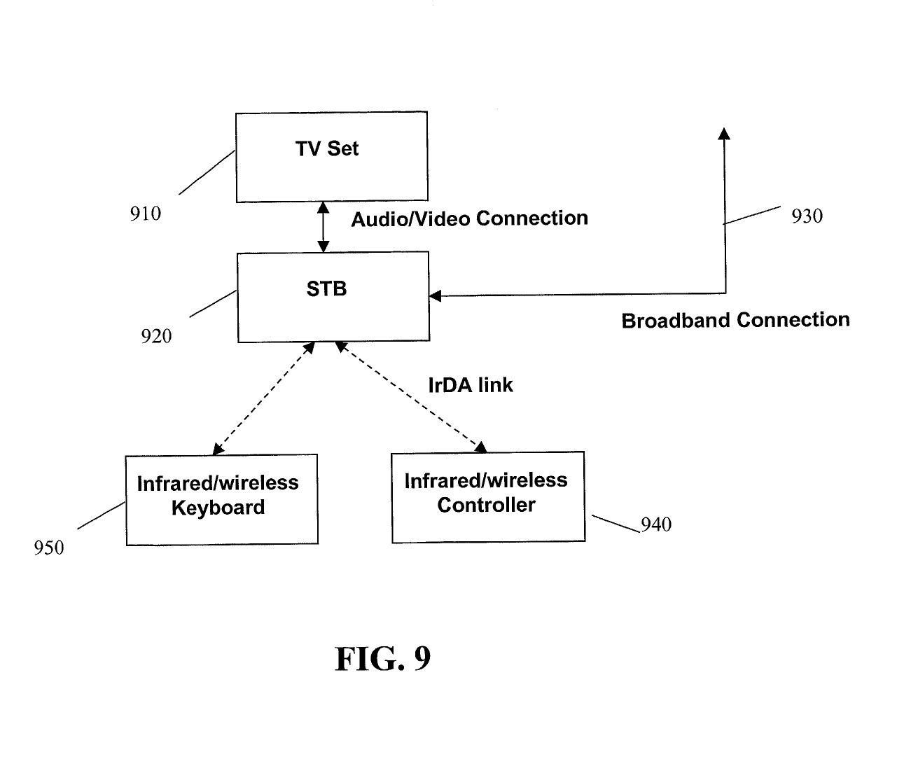

FIG. 9 is a simplified block diagram illustrating one embodiment of a Set Top Box (STB). A consumer display device such as a consumer television 910 receives programs from the STB unit 920. The STB unit 920 is broadband ready and capable of communicating via a broadband connection 930 (13 as shown in FIG. 1) to the data creation and transmission system 12. In one embodiment, user communicates with the STB 920 by a wireless input unit such as a television remote controller 940 or a wireless keyboard 950. Alternatively, a wireless keyboard may be used to input the user selection to the STB unit 920. The STB unit 920 in turn transmits the user program or file selections to the data creation and transmission system 12.

The broadband ready STB 920 enables the user to access the various integrated telecommunication services of system 12 via the broadband connection 13 (FIG. 1). For example, the STB unit 920 may include a web browser allowing access to the Internet.

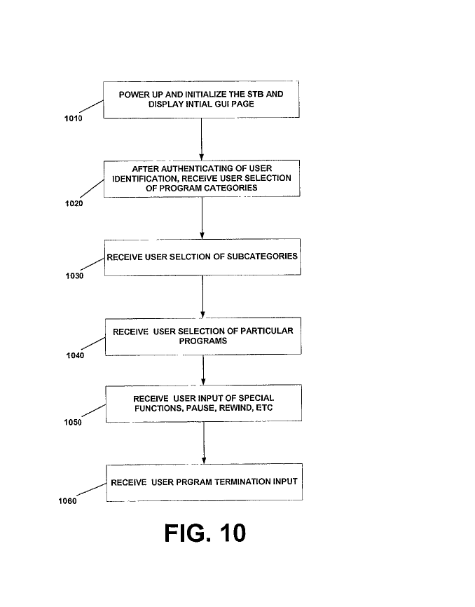

FIG. 10 is a flow diagram illustrating the principle operation steps implemented by the STB. In step 1010, upon power up, the STB 920 (FIG. 9) may initialize and configure its hardware and software systems. Upon initialization, the STB 920 may display through the television 910 (FIG. 9) the initial GUI sitting allowing the user to make a selection of the programs and services he desires.

In step 1020, user identification is loaded into the OSS server automatically, and after the user authentication is completed, the STB 920 may display the data creator and transmission system's main graphical user interface (GUI) page. In step 1020, the user input selects the category of programming desired such as news, sports or movies.

In step 1030, the user inputs its selections within a particular subcategory, such as the subcategory of football under the general category of sports. The user may use a television remote control device to navigate a virtual keyboard displayed on the television set 910 and enter his or her selections.

In step 1040, the user confirms his or her selection of a particular program and commits to it by particularly selecting and activating the selected program. In step 1050, the user selects various functions such as pause, rewind, or fast forward applied to the program being displayed on the television set 910. The user selects particular functions by using the input device, the television remote control 14 in this example, to select the special functions available to him by navigating and selecting from the On screen Display (OSD) title bar the desired function.

In step 1060 the user may terminate the display of the particular program by selecting the stop function or home icon on the title bar of the GUI interface. The selection of the stop/home button would allow the user to return to previous GUI interfaces where he may enter a new category, sub-categories and program selection.

It will be apparent to those skilled in the art that other GUI interfaces and program selection means may be used to implement the program selection function.

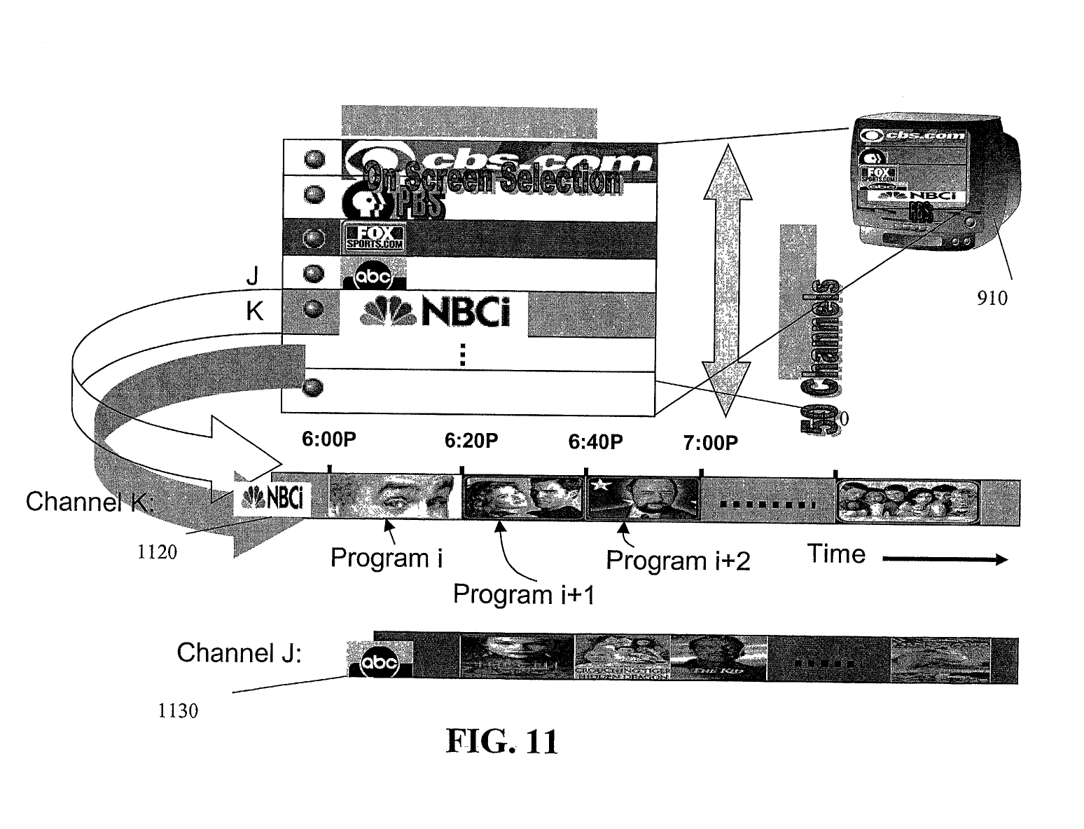

FIG. 11 illustrates one example of a GUI interface according to the present invention. The GUI interface 1100 allows the user to select the programs and function he desires by navigating through an intuitively straight forward program display interface such as the one shown in FIG. 11. In this example, the user may select a desired channel from a list of available channels 1110 in a first step. The GUI opens multiple new windows 1120 and 1130, displaying the available program selections broadcast over that channel during a given time period. It will be apparent to those skilled in the art, that the GUI interface 1100 may be customized by the user service level agreement and for example access to certain programs may restricted. This may accomplished by either not displaying the programs and channels to which access is restricted or not allowing the selection of such programs and channels. Selection of certain programs or channels may also be restricted by the user for purposes such as parental control. In one embodiment, the GUI interface is customized based on a user profile allowing the user to access to those services and programs based on his or her service level agreement.

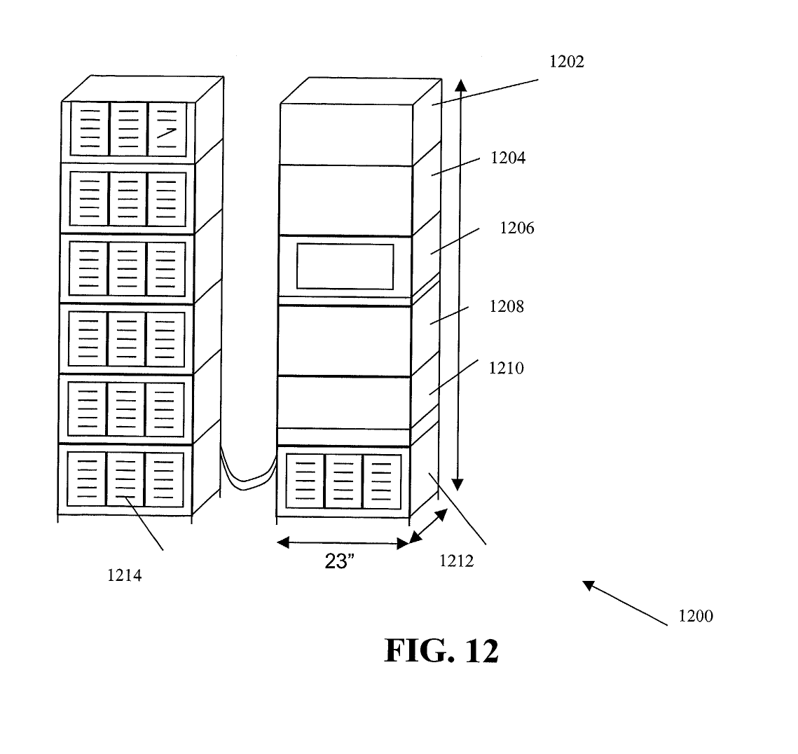

FIG. 12 illustrates one example of the scalable RAID system housing the data creator and transmission system 12. The RAID system housing 1200 includes space for peripheral A/V devices 1202, a multimedia content creator drawer 1204, an SVGA monitor slid-drawer 1206 for housing a keyboard with a mouse, an n-to-1 monitor/keyboard switch, an output unit housing 1208, a Digital Wavelength Division Multiplexing (DWDM) system 1210, a UPS power supply 1212, and a scalable RAID system housing a plurality of high capacity, high speed HDDs.

It would be apparent to one skilled in the art that the implementation of the teachings of the present invention is not limited to video files and the broadcasting and downloading systems and methods of the present invention may be applied to different mediums and different data types and files and different services.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

We claim:

1. A system for providing to system users IP centric, multi-channel, time-shifted and real time telecommunication services such as live television, television on demand, video on demand, and karaoke on demand, comprising:
a media content creator subsystem for receiving multiple video signal streams each having one of several industry standard communication format, and for converting the incoming video signal streams into digital data and compressing the digital data into IP based packets, for transmission over broadband network;
a storage means for storing IP based packets and permitting stored IP based packets to be retrieved therefrom;
a gateway means for receiving packets from multiple sources and combining such packets for transmission over a broadband communication network;
a media streaming subsystem for receiving, and forwarding streams of IP based packets, said media streaming subsystem being responsive to a user request and operative to forward a selected stream of IP based packets from either said content creator subsystem or said storage means to said gateway means or to retrieve stored streams of IP based packets from said storage means and forward the retrieved IP packets to said gateway means; and
a content management subsystem for controlling user access to the system and providing user account management.

2. The system of claim 1 wherein the content management subsystem provides at least: user authentication, user billing, intellectual property right management, management of quality of user services, and management of transmission channel bandwidth.

3. The system of claim 1 wherein the digital data are encoded based on MPEG1.

4. The system of claim 1 wherein the digital data are encoded based on MPEG2.

5. The system of claim 1 wherein the digital data are encoded based on MPEG4.

6. The system of claim 1 wherein the digital data are encoded based on H.263.

7. The system of claim 1 wherein the source of the incoming video signal streams may include satellite, off the air television broadcasting, digital versatile disk, video cassette recorder, and live camera and cable television.

8. The system of claim 1 wherein encoded digital data is packetized by the media streaming subsystem.

9. The system of claim 1 wherein the media streaming subsystem provides the user access to time-shifted television programming in an order selected by the user.

10. The system of claim 1 wherein the media streaming subsystem may simultaneously provide multiple streams of IP based packets each encoded based on a different standard.

11. The system of claim 1 wherein the entire system is scalable.

12. The system of claim 1 further comprising an output subsystem providing for seamless integration of the multiple telecommunication services including television on demand, video on demand, karaoke on demand, Internet services, and telephone services.

13. The system of claim 1 wherein the system is capable of providing services to both wired and wireless networks.

14. The system of claim 1 wherein the incoming video signal streams are in S-video format.

15. The system of claim 1 wherein the incoming video signal streams are in NTSC/PAL composite TV signal format.

16. The system of claim 1 wherein the incoming video signal streams are in RGB component video format.

17. The system of claim 1 wherein the incoming audio signal streams are in two sound tracks.

18. A method for providing IP centric, multi-channel, time-shifted and real time telecommunication services including live television, television on demand, video on demand, and karaoke on demand, said method comprising:
receiving multiple video signal streams each having one of several industry standard communication format by a media content creator subsystem, and converting the incoming video signal streams into digital data and compressing the digital data into IP based packets, for transmission over broadband network;
storing IP based packets and permitting stored IP based packets to be retrieved from a storage means;
receiving packets from multiple sources via a gateway means and combining such packets for transmission over a broadband communication network;
receiving and forwarding streams of IP based packets using a media streaming subsystem being responsive to a user request and operative to forward a selected stream of IP based packets from either said content creator subsystem or said storage means to said gateway means or to retrieve stored streams of IP based packets from said storage means and forward the retrieved IP packets to said gateway means; and
controlling user access to the system and providing user account management.

19. The method of claim 18 further providing at least one of: user authentication, user billing, intellectual property right management, management of quality of user services, and management of transmission channel bandwidth.

20. The method of claim 18 wherein the digital data are encoded based on MPEG1.

21. The method of claim 18 wherein the digital data are encoded based on MPEG2.

22. The method of claim 18 wherein the digital data are encoded based on MPEG4.

23. The method of claim 18 wherein the digital data are encoded based on H.263.

24. The method of claim 18 wherein the source of the incoming video signal streams may include satellite, off the air television broadcasting, digital versatile disk, video cassette recorder, and live camera and cable television.

25. The method of claim 18 wherein encoded digital data is packetized by a media streaming subsystem.

26. The method of claim 18 wherein the media streaming subsystem provides the user access to time-shifted television programming in an order selected by the user.

27. The method of claim 18 wherein the media streaming subsystem may simultaneously provide multiple streams of IP based packets each encoded based on a different standard.

28. The method of claim 18 wherein the entire system is scalable.

29. The method of claim 18 further comprising providing for seamless integration of the multiple telecommunication services including television on demand, video on demand, karaoke on demand, Internet services, and telephone services.

30. The method of claim 18 wherein the applicable for providing services to both wired and wireless networks.

31. The method of claim 18 wherein the incoming video signal streams are in S-video format.

32. The method of claim 18 wherein the incoming video signal streams are in NTSC/PAL composite TV signal format.

33. The method of claim 18 wherein the incoming video signal streams are in RGB component video format.

34. The method of claim 18 wherein the incoming audio signal streams are in two sound tracks.

35. A computer program embodied on a computer readable medium for providing IP centric, multi-channel, time-shifted and real time telecommunication services including live television, television on demand, video on demand, and karaoke on demand, comprising:
a code segment for receiving multiple video signal streams each having one of several industry standard communication format by a media content creator subsystem, and converting the incoming video signal streams into digital data and compressing the digital data into IP based packets, for transmission over broadband network;
a code segment for storing IP based packets and permitting stored IP based packets to be retrieved from a storage means;
a code segment for receiving packets from multiple sources via a gateway means and combining such packets for transmission over a broadband communication network;
a code segment for receiving and forwarding streams of IP based packets using a media streaming subsystem being responsive to a user request and operative to forward a selected stream of IP based packets from either said content creator subsystem or said storage means to said gateway means or to retrieve stored streams of IP based packets from said storage means and forward the retrieved IP packets to said gateway means; and
a code segment controlling user access to the system and providing user account management.

36. The computer program product of claim 35 wherein the content management subsystem provides at least: user authentication, user billing, intellectual property right management, management of quality of user services, and management of transmission channel bandwidth.

37. The computer program product of claim 35 wherein the digital data are encoded based on MPEG1.

38. The computer program product of claim 35 wherein the digital data are encoded based on MPEG2.

39. The computer program product of claim 35 wherein the digital data are encoded based on MPEG4.

40. The computer program product of claim 35 wherein the digital data are encoded based on H.263.

41. The computer program product of claim 35 wherein the source of the incoming video signal streams may include satellite, off the air television broadcasting, digital versatile disk, video cassette recorder, and live camera and cable television.

42. The computer program product of claim 35 wherein encoded digital data is packetized by a media streaming subsystem.

43. The computer program product of claim 35 wherein the media streaming subsystem provides the user access to time-shifted television programming in an order selected by the user.

44. The computer program product of claim 35 wherein the media streaming subsystem may simultaneously provide multiple streams of IP based packets each encoded based on a different standard.

45. The computer program product of claim 35 wherein the entire system is scalable.

46. The computer program product of claim 35 further comprising a computer program product for providing for seamless integration of the multiple telecommunication services including television on demand, video on demand, karaoke on demand, Internet services, and telephone services.

47. The computer program product of claim 35 wherein the applicable for providing services to both wired and wireless networks.

48. The computer program product of claim 35 wherein the incoming video signal streams are in S-video format.

49. The computer program product of claim 35 wherein the incoming video signal streams are in NTSC/PAL composite TV signal format.

50. The computer program product of claim 35 wherein the incoming video signal streams are in RGB component video format.

51. The computer program product of claim 35 wherein the incoming audio signal streams are in two sound tracks.

52. A method for receiving IP centric, multi-channel, time-shifted and real time telecommunication services including live television, television on demand, video on demand, and karaoke on demand, said method comprising:
transmitting a user selection of a television program to a remote system, wherein said system receives multiple format incoming video signals from multiple sources, converts the incoming video signals into digital data; encodes the digital data into IP based packets based on multiple compression standards, wherein said IP packets may be ready for transmission over a network, stores the IP based packets in an indexed, accessible database; and provides multiple streams of IP based packets to the user upon request, over a broadband communication channel;
receiving streams of IP based packets representing the user selected television program.

52. A method for providing IP centric, multi-channel, time-shifted and real time telecommunication services including live television, television on demand, video on demand, and karaoke on demand, said method comprising:
converting multiple format video signal streams into IP based packets ready for transmission over broadband networks;
receiving, storing and forwarding the IP based packets, based on a request from a user, each said IP based packets including data representing the converted and encoded content of a user requested program file;
providing user account management including controlling user access to the entire system;
providing a user interface means for a user to select time-shifted telecommunication services; and
providing means for transmitting the user selected, IP based packets to the user over a broadband network.
